(19) United States
(12) Patent Application Publication
(10) Pub. No.: US 2015/0184761 A1
(43) Pub. Date: Jul. 2, 2015

(54) ROTARY VALVE SEAL MEMBER AND ROTARY VALVE USING SAME

(71) Applicant: NIPPON THERMOSTAT CO., LTD., Tokyo (JP)

(72) Inventor: Fumito Kusakabe, Tokyo (JP)

(73) Assignee: NIPPON THERMOSTAT CO., LTD., Tokyo (JP)

(21) Appl. No.: 14/415,129

(22) PCT Filed: Jan. 28, 2013
(86) PCT No.: PCT/JP2013/051783

§ 371 Date: Jan. 15, 2015

(30) Foreign Application Priority Data
Aug. 10, 2012 (JP) 2012-178864

(51) Int. Cl. F16K 5/06

(52) U.S. Cl. CPC F16K 5/0689

(57) ABSTRACT

A rotary valve seal member that is held in sliding contact with a valve element that rotates, turns, or slides within a valve housing of a rotary valve and is capable of providing a secure seal as the valve element operates. The seal member has the structure of a three-dimensional ring having a cross-section composed of an oval portion, aligned with a normal line to the outside of the valve element and having a bulge at the end that protrudes and presses against the outer surface of the valve element, and a rectangular portion, into which the oval portion is integrated in a state in which the oval portion is aligned with the normal line to the outside of the valve element, that is retained within an annular groove with the outer side of the rectangular portion in contact with the wall of the annular groove.

### TECHNICAL FIELD

The present invention relates to a rotary valve seal member for sealing a cylindrical or spherical valve element that rotates, turns, or slides, from flow control valves used in automobile cooling systems and the like to rotary valves such as ball valves used in water faucets and other plumbing fixtures, and to a rotary valve using the same.

### BACKGROUND ART

In rotary-type flow rate control valves used in automobile cooling systems, for example, a container arrangement in which a substantially cylindrical valve element inside a valve housing can be rotated is known (see, for example, Patent Document 1).

Briefly, in this rotary-type flow rate control valve, together with using a cylindrical valve element, an annular seal ring is inserted into an annular groove formed in the rim of an opening of a passage provided continuous with a valve chamber inside the valve housing to prevent fluid leakage and to provide the desired operation by moving the valve element to open and close the fluid passage and opening and closing the passage as appropriate.

In the ball valve construction used in housing facilities, a spherical or cylindrical valve element is disposed inside valve housing and an annular seal member is fitted into an annular groove inside the valve housing so as to contact the outer peripheral surface of the valve element. Bulges and grooves are formed in the seal member on the valve element side and the valve housing side, such that, when the valve element is operated from the outside, the seal member is between the valve element and the valve housing and can maintain the necessary seal (see, for example, Patent Document 2).

### PRIOR ART DOCUMENTS

### Patent Documents

Patent Document 1: JP-2000-018039-A

Patent Document 2: JP-2000-346213-A

### SUMMARY OF THE INVENTION

### Technical Problem

With a spherical or cylindrical valve element that rotates or turns inside the valve housing as described above, an annular seal member that slides over the outer peripheral surface of the valve element and seals the portion of the valve element against which it slides is provided. Although a variety of different shapes have been suggested for that seal member, each has advantages and disadvantages, making some sort of solution desirable.

More specifically, with the ordinary O-ring used as a seal member, when inserted between the valve element and the valve housing, the O-ring, which contacts the outer surface of the valve element, gets wrenched and twisted by the rotation of the valve element, requiring provision of a reinforcing member on the inside and the outside of the O-ring, thereby increasing the number of parts and assembly steps, unavoidably complicating assembly, and requiring that the space between the reinforcing member and the O-ring be made small to prevent the O-ring from getting caught therein. Moreover, the seal must be designed so as to avoid complications such as the reinforcing member contacting the valve element and creating sliding resistance.

Alternatively, to prevent an ordinary O-ring from getting twisted or caught without employing reinforcing members, conceivably the O-ring could be made thick. However, if the O-ring is made thick, everything else becomes bigger as well, from the dimensions of the O-ring in the direction of compression (groove depth) to the inner and outer diameters of the O-ring (groove width), leading not only to an overall increase in the size of the valve but also to an increase in sliding resistance since the area of the outer surface of the valve element that the seal member contacts as the valve element slides increases, risking problems such as hindering movement of the valve element and wearing out the O-ring.

Therefore, some sort of solution is desired that spreads the compression of the seal member due to contact with the outer surface of the valve element evenly over the entire circumference of the seal member without making the O-ring thicker, and without requiring more parts to keep the O-ring from getting caught.

In addition, instead of making the O-ring thicker as described above, use of an oval- or elongated oval-shaped O-ring that provides the same rate of compression is also conceivable. However, with this sort of oval-shaped O-ring, if the shape of the outer surface on the valve element side is curved, for example, there appear locations where the prescribed compression rate cannot be obtained. That is, because the O-ring cannot be disposed so that the axis of the oval faces the center of the curved outer surface of the valve element, the compressive force of the outer surface of the valve element works in a direction offset from the axis of the oval-shaped O-ring, the right amount of compressive force cannot be obtained, the seal deteriorates, the O-ring tends to get twisted by the outer surface of the valve element, and even with this configuration the seal is degraded.

Accordingly, as described above conventionally a variety of different approaches have been tried. Thus, in the conventional art described above, bulges and grooves are formed in the sides of the seal member facing the valve element and the valve housing to improve adhesion to the outer surface of the valve element to provide a good seal at that part.

However, a seal member having this sort of complicated cross-section not only lacks formability but also suffers abrasion and damage to the bulges the more frequently it is used, and the seal is thus damaged. Moreover, the molds used to form the seal member also get complicated and unavoidably wear out, which is another cost problem.

In addition, conventionally approaches have been proposed in which, in this type of conventional rotary valve, the seal member is pressed against the side of the valve by a leaf spring, the passage protrudes into the interior of the housing in the form of a pipe-shaped projection that penetrates the seal member and is held in place by a stop ring or the like, with mechanical rigidity improved by using a metal core or the like.

However, with this sort of conventional structure, despite the seal member being configured solely as an elastic body, the seal member itself and the shape of the groove in the housing get complicated, and burrs appear on the seal member since the seal has a lot of corners, necessitating their removal and thereby increasing the number of manufacturing steps.

Moreover, with the conventional seal member, the tension at the point of contact with the valve element is offset from the normal line to the center of the valve element, creating a deflected force that tends to cause the seal member to abrade easily from sliding friction caused by extended use, and the required tension cannot be maintained over an extended period of time, leading to a durability problem. In particular, with the conventional seal member, as described above the compression rate differs at each location along the circumference of the seal member and it is difficult to make the tension on the outer surface of the valve element uniform at every point along the circumference of the seal member. This unevenness in the tension at each location along the circumference of the seal member makes it impossible to provide a secure seal.

The present invention is conceived in light of the circumstances described above, and has as its object to provide a rotary valve that makes uniform the compression rate at each location along the circumference contacting a valve element that rotates, turns, or slides, to ensure a secure seal regardless of the state of the valve element, whether open or closed.

Solving the Technical Problem

To achieve this objective, the present invention (the invention according to claim 1) provides a rotary valve seal member for a rotary valve having a cylindrical or spherical valve element that rotates, turns, or slides within a valve housing, comprising a portion of an inner wall surface curved to conform to an outer surface of the valve element within the valve housing, and fitted into an annular groove formed in a rim of an opening of a passage that is opened and closed by the valve element in such a way that the seal member slides over the outer surface of the valve element, wherein the seal member has the structure of a three-dimensional ring having a cross-section composed of an oval portion that is aligned with a normal line to the outer surface of the valve element, with a first bulge at an end of the oval portion protruded and pressed against the valve element outer surface to seal a portion in contact with the outer surface of the valve element, and a rectangular portion, embedding the oval portion in a state in which the oval portion is aligned with the normal line to the outer surface of the valve element, which is retained within an annular groove, with an outer side of the rectangular portion in contact with a wall of the annular groove, wherein the seal member is integrally formed of an elastic material.

The present invention (the invention according to claim 2) provides the rotary valve seal member as claimed in claim 1, further comprising a second bulge on an end of the seal member opposite the first bulge and protruding in a direction opposite the normal line so that the seal member is pressed against a floor of the annular groove of the valve housing to exert a biasing force in the direction of the normal line, wherein the seal member forms a ring having a cross-sectional shape that includes the second bulge.

The present invention (the invention according to claim 3) provides the rotary valve seal member as claimed in claim 1 or claim 2, wherein the seal member has an oval portion forming an oval-shaped cross-section having the first bulge and the second bulge, and has a cross-section such that a direction of compression to which the seal member is subjected when the seal member is retained in the annular groove and slides over the outer surface of the valve element is on the normal line to the outer peripheral surface of the valve element and the same compression rate is maintained at all locations along the circumference of the seal member.

The present invention (the invention according to claim 4) provides the rotary valve seal member as claimed in any one of claims 1 through 3, wherein the oval portion that slides over the outer surface of the valve element has a cross-sectional shape that changes continuously along the circumference of the oval portion so that the oval portion is always aligned with the normal line to the outer surface of the valve element.

The present invention (the invention according to claim 5) provides the rotary valve seal member as claimed in claim 4, wherein the rectangular portion of the seal member has a side forming a ring having an outer peripheral surface retained by the wall of the annular groove and an inner peripheral surface having an inner diameter dimensioned so as not to constrict the opening of the passage, being coaxial with a rotatable shaft of the valve element and larger than the outer surface of the valve element viewed from the valve element, and a side smaller than a floor of the annular groove viewed from a side opposite the valve element.

The present invention (the invention according to claim 6) provides the rotary valve comprising the rotary valve seal member according to any one of claims 1 through 5, wherein a clearance greater than a gap into which the seal member protrudes when compressed is provided between an inner wall of the valve housing of the rotary valve and an outer surface of the valve element.

### Effects of the Invention

The rotary valve seal member according to the present invention as described above comprises a portion of an inner wall surface curved to conform to an outer surface of the valve element within the valve housing, and fitted into an annular groove formed in a rim of an opening of a passage that is opened and closed by the valve element in such a way that the seal member slides over the outer surface of the valve element, wherein the seal member has the structure of a three-dimensional ring having a cross-section composed of an oval portion that is aligned with a normal line to the outer surface of the valve element, with a first bulge at an end of the oval portion protruded and pressed against the valve element outer surface to seal a portion in contact with the outer surface of the valve element, and a rectangular portion, embedding the oval portion in a state in which the oval portion is aligned with the normal line to the outer surface of the valve element, which is retained within an annular groove, with an outer side of the rectangular portion in contact with a wall of the annular groove, wherein the seal member is made of an elastic material, and as such provides various superior effects as described below.

(1) The annular groove inside the valve housing is disposed in the rim of an opening of a passage inside the housing and is constructed of a floor that is coaxial with the axis of rotation of the valve element and an inner wall that is coaxial with the passage opening. The groove floor, which is curved in the shape of an arc, is the portion that seats the second bulge in the oval portion of the seal member, and the groove wall is formed for the purpose of holding the rectangular portion of the seal member. The seal member is composed of an oval portion itself composed of first and second bulges (the second bulge on the side away from the valve element may be omitted) and a rectangular portion forming a ring (a doughnut-shaped member) having an outer circumference retained by the inner wall of the annular groove and an inner circumference of an extent that does not constrict the passage opening, the ring being coaxial with a movable shaft of the valve element and having a first side larger than the outer surface of the valve element (viewed from the valve element side) and a second side smaller than the floor of the annular groove (viewed from the side opposite the valve element side).

Therefore, the oval portion chiefly functions to seal the space between the outer surface of the valve element that rotates and slides and the floor of the annular groove inside the valve housing, and although compression perpendicular to the long axis of the oval portion connecting the centers of the first and second bulges is ideal, the seal member forms a three-dimensional structure such that every portion facing both arc-shaped compression walls is always aligned with the normal line so that the same compression rate is obtained all along the space between the two arc-shaped compression walls, with the result that the seal member according to the present invention can maintain a secure seal with the outer surface of the valve element.

(2) Forming the oval portion, which is the portion that determines the amount of compression of the seal member, an oval portion like that described above makes it possible to secure an amount of compression equivalent to that of the simple, thick O-ring that is ordinarily used, but without enlarging the area of contact of the sliding surface and without increasing the sliding resistance.

Adopting this sort of configuration also has the advantage of increasing the dimensional tolerances of the compression wall.

(3) The rectangular portion of the seal member is retained within the annular groove in the valve housing and functions to position the seal member in the radial direction to the axis of rotation of the valve element and in the direction of thrust of the valve element, as well as to reliably prevent (during compression) twisting and drooping of the oval portion with which the rectangular portion shares a portion of its volume and wrenching and protrusion of the seal member caused by sliding over the outer peripheral surface of the valve element.

(4) The first side of the rectangular portion in the seal member (the side facing the valve element) is designed to not contact the outside of the valve element, and thus does not impart sliding resistance to the valve element. Moreover, as described above the seal member is preformed in the shape of an arc that is concentric with the axis of rotation of the valve element, so after insertion in the annular groove and fitting onto the valve, the seal member does not protrude and does not get dislocated, and moreover is not subjected to localized stress after assembly and during operation of the valve element, so there is no localized friction or partial drooping, and thus the seal member has superior durability.

(5) By placing the annular groove that holds the seal member inside the valve housing, there is no need for a cover to retain the seal member as in a case in which the seal member is designed to be fitted from the outside, and as a result there is no need for a seal member between the cover and the housing, thereby enabling the number of component parts to be reduced and greatly improving the reliability of the seal against outside air.

(6) The seal member provides a more reliable and more durable seal, does not require a back-up ring to prevent protrusion, keeps the number of component parts to a bare minimum, and does not employ expensive parts, and therefore can be made inexpensively in terms of cost.

Moreover, according to the present invention, using a rotary valve seal member having the operational effects described above has the advantage that a larger clearance can be provided between the inner wall of the valve housing and the outer peripheral surface of the valve element than in the case of a conventional seal member such as an O-ring, that is, a clearance larger than a gap into which the seal member protrudes when compressed, so that impurities contained in the fluid (for example, metal shavings remaining from the time the engine block was made) do not get caught and good valve action is obtained at all times. This is because, conventionally, this clearance is made as close to zero as possible by using a back-up ring taking into account the protrusion of the seal member into the clearance when the valve slides; in other words, this clearance was made smaller than the gap into which the seal member protrudes when compressed in an effort to prevent damage to the seal member, but as a result, impurities could easily clog the valve. If the clearance were to be made large it would lead to the above-described problem of the seal member protruding into the gap, which was a real problem in actual usage. With the seal member according to the present invention, however, this sort of problem can be solved.

### BRIEF DESCRIPTION OF THE DRAWINGS

FIGS. 1(a), (b) are views illustrating chief portions, and an enlarged view of a portion B, respectively, of one embodiment of a rotary valve seal member (annular seal member) according to the present invention;

FIG. 2 is a schematic perspective view of the rotary valve seal member that is a distinctive feature of the present invention;

FIGS. 3(a), (b), (c), (d) are front (viewed from the valve element), side, plan, and bottom views, respectively, of the rotary valve seal member shown in FIG. 2;

FIG. 4 is a sectional view along line IV-IV in FIG. 3(d);

FIG. 5 is a sectional view along line V-V in FIG. 3(d);

FIGS. 6(a), (b) are views illustrating the relation between the annular groove and the seal member of the rotary valve, showing a schematic perspective view of the valve housing and a sectional view of the center of the valve housing showing the portion where the annular groove is formed, respectively;

FIG. 7 is a schematic explanatory view illustrating the shape of the seal member that is a distinctive feature of the present invention, in particular a rectangular portion thereof;

FIGS. 8(a), (b) are a schematic sectional view and a sectional view along line B-B of a flow control valve adopting the rotary valve seal member according to the present invention; and

FIG. 9 is a schematic perspective view of the rotary valve element used in a rotary-type flow control valve device.

### DETAILED DESCRIPTION OF EMBODIMENTS OF THE INVENTION

An annular seal member that seals a portion in contact with the outer surface of a valve element that rotates, turns, or slides is formed as a ring having in cross-section an oval portion that is aligned with the normal line to the outer surface of the valve element, with a bulge at the end of the seal member protruded and pressed against the valve element outer surface, and a rectangular portion, embedding the oval portion in a state in which the oval portion is aligned with the normal line to the outer surface of the valve element, with the outside of the rectangular portion in contact with and retained by the wall of an annular groove inside the valve housing.

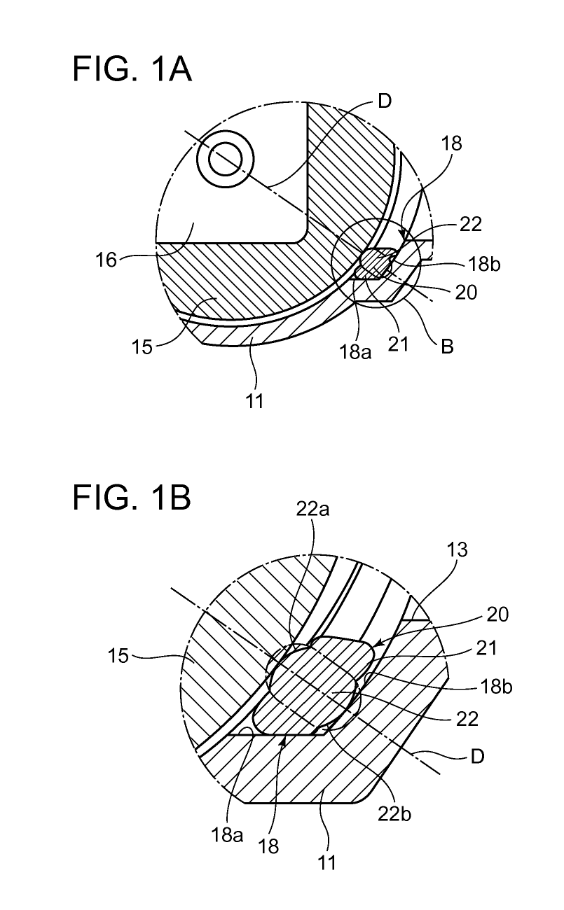

FIGS. 1 through 5 show a rotary valve seal member according to the present invention and an embodiment of a rotary valve using the seal member. The present embodiment is described using as an example a case in which the seal member is adapted to a rotary valve used as a flow control valve in an appropriate fluid device.

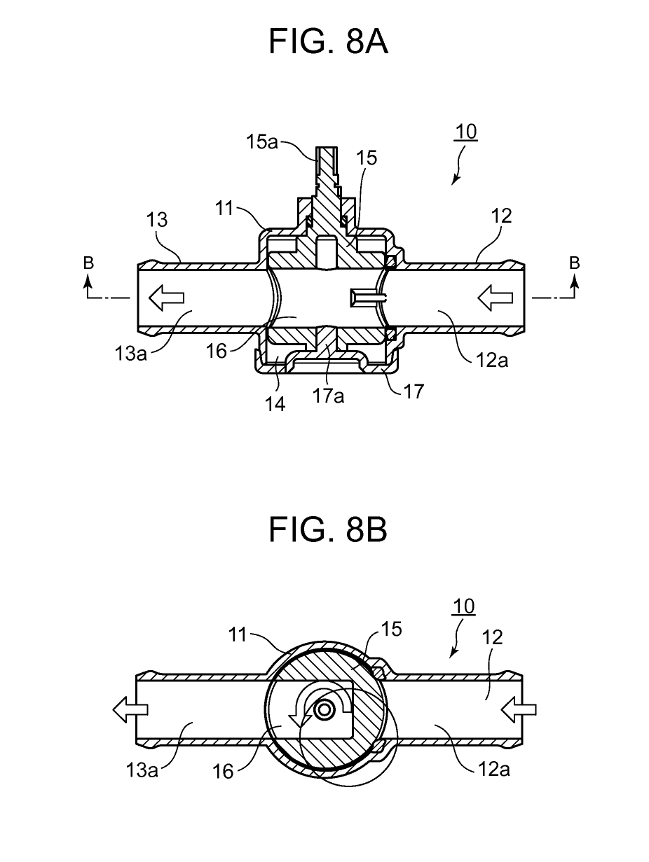

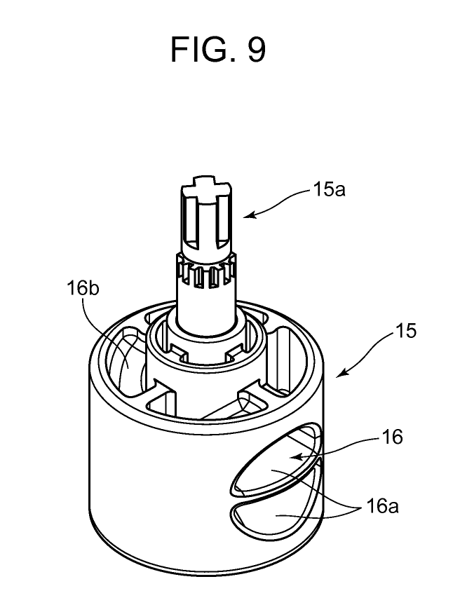

A flow control valve adopting the rotary valve seal member that is a distinctive feature of the present invention is described below using FIGS. 8(a), (b) and FIG. 9.

Reference numeral 10 denotes a flow control valve as the rotary valve, in which a valve housing 11 is fitted with an inflow pipe 12 and an outflow pipe 13. A rotatable cylindrical valve element 15 shown in FIG. 5 is contained within a central valve chamber 14. When a handle shaft 15a that protrudes from the valve housing 11 is turned, the valve element 15 rotates as appropriate and the passage port 16 in which the valve element 15 is installed communicates the pipes 12 and 13 in degrees corresponding to how much the handle shaft 15a is turned to control the flow.

It should be noted that, in FIG. 8(a), reference numerals 12a and 13a denote the internal passageways of the inflow and outflow pipes 12, 13 respectively. In addition, 17 denotes a cover that closes a hole in the bottom of the valve housing 11 and 17a is a shaft that projects into the interior from the inside of the cover 17. The shaft 17a and the handle shaft 15a together rotatably support the cylindrical valve element 15 inside the housing 11.

Moreover, in FIG. 9, reference numerals 16a, 16b are passageway openings that control fluid flow through the passage port 16 in the sides of the valve element 16.

According to the present invention, a seal member 20 is disposed so as to be in sliding contact with the outer surface (in the present embodiment, the outer peripheral surface) of the valve element 15 formed in the shape of a cylinder that rotates, turns, or slides inside the valve housing 11 of the flow control valve device 10 as a rotary valve having the configuration described above, and this seal member 20 is held in place inside an annular groove 18 formed in the rim of the opening of the outflow pipe 13 that opens into the valve chamber 14 inside the valve housing 11 so as to seal the space between it and the outer peripheral surface of the valve element 15 to prevent the occurrence of leaks into the passageways and to the outside.

As shown in FIG. 1 through FIG. 7, the seal member 20 has the structure of a three-dimensional ring having a cross-section consisting of a rectangular portion 21, shaped so as to be embedded in and retained inside the annular groove 18 formed in the rim of the opening of the passageway that is opened and closed by the valve element 15, and an oval portion 22 having a bulge 22a (a first bulge) whose tip projects in the direction of a normal line D to, and is pressed against, the outer peripheral surface of the valve element 15.

In other words, the seal member 20 that is the distinctive feature of the present invention has an oval portion 22 aligned with the normal line to the outer peripheral surface of the valve element 15, and this oval portion 22 is integrated into the rectangular portion 21 so that the long axis of this oval portion 22, at every point along the circumference of the seal member 20, is aligned with the normal line to the outer peripheral surface of the valve element 15.

The annular groove 18 inside the valve housing 11 is disposed in the rim of the passageway opening inside the housing 11 and is constructed of a floor 18b coaxial with the center of the shaft (17a) of the valve element 15 and a wall 18a coaxial with the center of the passage. The groove floor 18b, which is bent in the shape of an arc, is the portion that seats a second bulge 22b in the oval portion 22 of the seal member 20, and the groove wall 18a is configured for the purpose of holding the rectangular portion 21 of the seal member 20.

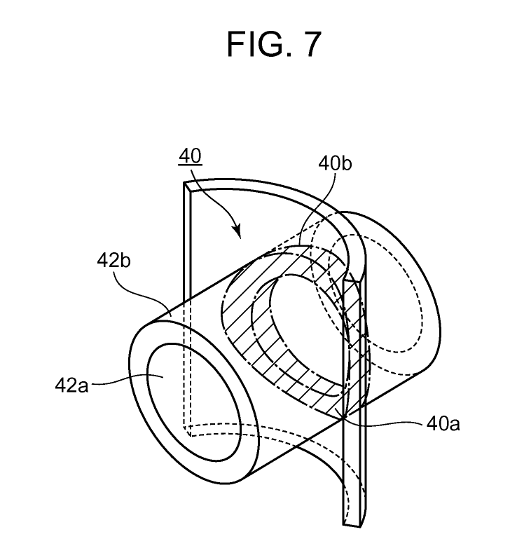

More specifically, the seal member 20 is composed of the oval portion 22 having the first and second bulges 22a, 22b, and the rectangular portion 21 having a side 40a (a first side) forming a ring (the doughnut-shaped portion indicated by reference numeral 40 in FIG. 7) having an outer peripheral surface 42b retained by the inner wall of the annular grove 18 and an inner peripheral surface 42a having an inner diameter dimensioned so that it does not constrict the passage opening, and is coaxial with the axis of rotation (the rotatable handle shaft 15a) and larger than the outer peripheral surface of the valve element 15 viewed from the valve side, and a side 40b (a second side) viewed from the side opposite the valve element 15 that is smaller than the floor 18b of the annular groove 18. It is to be noted that the thickness of the ring 40 is a matter of design convenience, governed by the seal hardness and materials, the required seal strength, the sliding resistance and the diameter of the opening, etc.

The rectangular portion 21 is shaped substantially in the form of a parallelogram in cross-section having a side that contacts the groove wall 18a of the annular groove 18 formed in the valve housing 11, and is configured so as to be retained stably within the annular groove 18 during installation. This rectangular portion 21 not only functions to position the seal with respect to the radial direction and the thrust direction of the valve shaft 17a but also functions to reliably prevent the oval portion 22 and the rectangular portion 21, which share a portion of their volume in common, from getting wrenched when compressed and getting twisted and dislocated by sliding contact with the outer peripheral surface of the valve element 15.

Moreover, the first side 40a of the rectangular portion 22 in the seal member 20 (the side facing the valve element) is dimensioned so as not to contact the outer surface of the valve element 15, and therefore does not apply sliding resistance to the valve element 15. Further, the seal member 20, as described above, is preformed in the shape of an arc concentric with the axis of rotation of the valve element 15, and therefore the seal member 20 does not protrude or get dislocated after insertion into the annular groove 18 and fitting onto the valve element 15, and moreover is not subjected to localized stress after assembly and during operation of the valve element 15, there is no localized friction or partial drooping, and thus the seal member 20 has superior durability.

Uninstalled, the length in the direction of the thickness of the rectangular portion 21 of the seal member 20 is shorter than the length of a line connecting the tips of the first and second bulges 22a, 22b of the oval portion 22.

Moreover, when the seal member 20 is installed and the valve element 15 is not operating, the rectangular portion 21 and the grove floor 18b of the annular groove 18 may either contact each other or not contact each other.

More specifically, the rectangular portion 21 in the seal member 20 contacts the groove wall 18 and is retained within the annular groove 18, and the oval portion 22 that slides over the outer peripheral surface of the valve element 15 has a cross-sectional shape that changes continuously along the circumference thereof so that the oval portion 22 is always aligned with the normal line to the outer peripheral surface of the valve element 15.

Moreover, the seal member 20 is formed such that, on the side opposite the bulge 22a, the seal member 20 is pressed against the groove floor 18b of the annular groove 18 of the valve housing 11 by protruding in a direction opposite the normal line, having a second bulge 22b that biases the bulge 22 in the direction of the normal line. Thus, the seal member 20 forms a ring with a three-dimensional structure having a cross-sectional shape that includes this second bulge 22b as well.

In the present embodiment, the portion that functions as the oval portion 22, which has a substantially oval shape extending along the normal line through the bulge (the first bulge) 22a and the second bulge 22b, is formed so as to be integrated with the rectangular portion 21. Thus, the oval portion 22 of the seal member 20 that is formed by the first bulge 22a and the second bulge 22b is configured so as to always be able to maintain the same compression rate (tension) at all points along the circumference.

Moreover, the direction of compression to which the seal member 20 is subjected while sliding along the outer peripheral surface of the valve element 15 while the seal member 20 is retained within the annular groove 18 is perpendicular to the groove floor 18b of the annular groove 18.

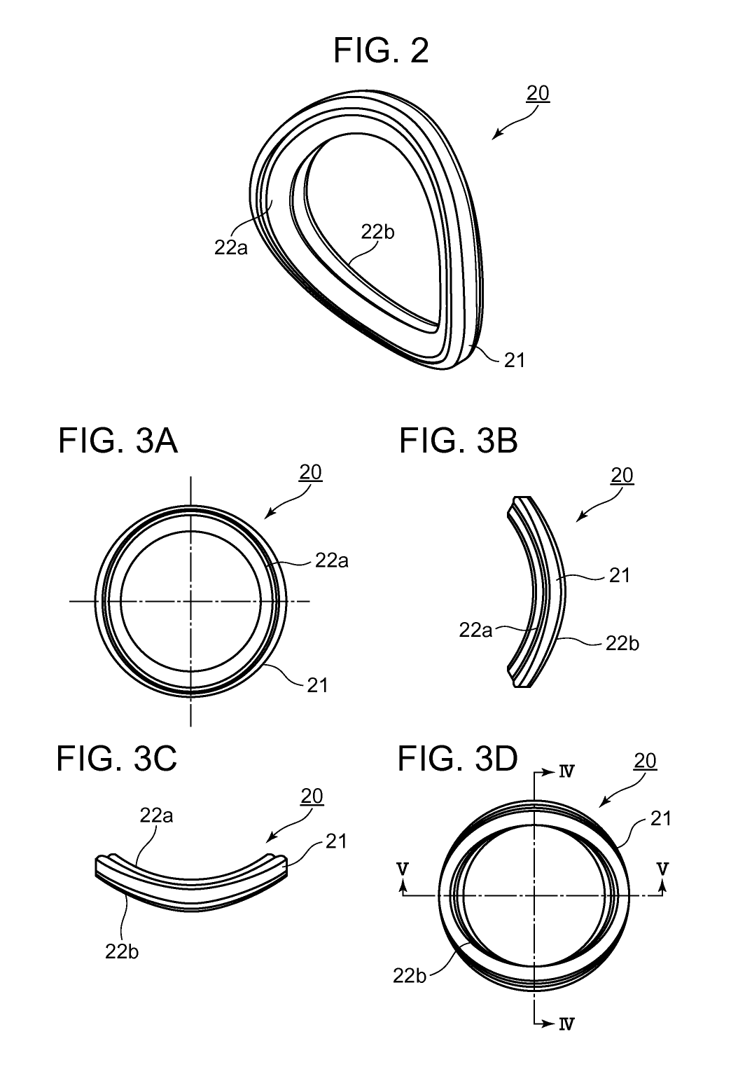

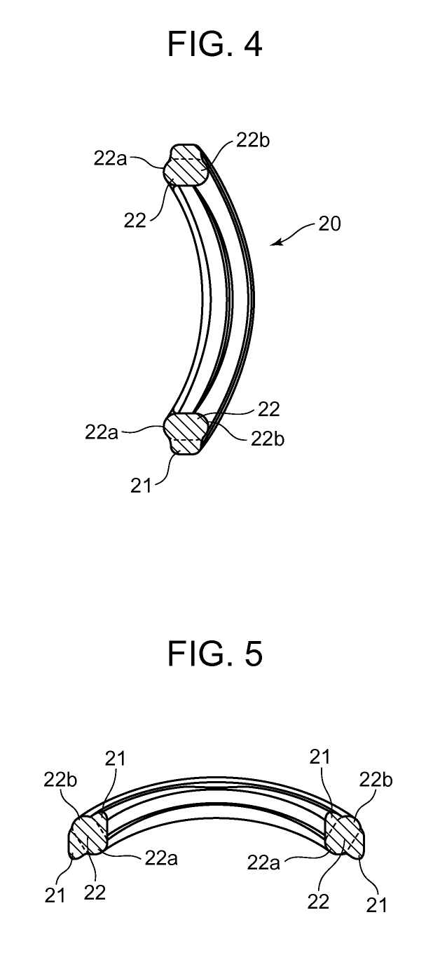

In addition, as is clear from FIG. 2, and FIGS. 3(a), (b), (c), (d), and further in the cross-sectional diagrams shown in FIG. 4 and FIG. 5, the overall shape of the seal member 20 is that of a ring. By imparting a curve to the side that contacts the outer peripheral surface of the valve element 15, the seal member 20 is given a three-dimensional shape that conforms to the shape of the outer peripheral surface of the valve element 15, thereby providing a good seal when the fluid passage within the passageway formed inside the valve housing 11 is shut off.

With the above-described configuration, the seal member 20 is disposed securely within the annular groove 18 inside the valve housing 11 by the rectangular portion 21, because the rectangular portion 21 contacts the groove wall 18a of the annular groove 18 and the second bulge 22b of the oval portion 22 contacts the groove floor 18b, and the seal member 20 is subjected to a prescribed tension so as to restrict movement thereof. Therefore, even as the valve element rotates and turns and slides over the seal member, the seal member is not wrenched loose. Moreover, with the rectangular portion 21 and the groove floor 18b of the annular groove 18, there is no risk of wrenching or twisting of the seal member 20 occurring when the valve element 15 rotates and slides, thereby providing superior durability.

In addition, by providing the cylindrical valve element 15 so as to contact the seal member 20, the tip of the bulge 22a provided so as to project toward the valve element 15 slides over the outer peripheral surface of the valve element 15, thereby providing a seal at this portion.

In particular, according to the present invention, the annular seal member 20 has a three-dimensional shape that conforms to the outer peripheral surface of the valve element 15, such that, at any cross-section along its entire circumference, the tip of the oval portion is aligned with the normal line D to the outer peripheral surface of the valve element 1, and biased so that the tip of the first bulge 22a is pressed in the direction of that normal line D. Therefore, a required biasing force along the normal line is exerted on this tip of the bulge 22a that contacts the valve element 15 of the seal member by the oval portion 22 that includes the second bulge 22b to reliably ensure a secure seal. Further, this biasing provides a certain amount of sealing even as the valve deteriorates with use, is damaged, etc.

In other words, by always maintaining the direction of the points of contact of the first bulge 22a and the second bulge 22b of the oval portion 22 of the seal member 20 (the direction in which the seal member rebounds) coincident with the normal line to the valve element 15 and the groove floor of the annular groove 18 at all cross-sections, tension (compression rate) of the seal member 20 can be reliably ensured, providing a secure seal.

In addition, with the bulge 22a of the oval portion 22 of the seal member 20, uniform compression can be obtained all along the outer peripheral surface of the valve element and the groove floor of the annular groove, thereby providing the performance required as the seal member 20.

To describe the outlines of the basic structure of the overall shape of the seal member 20: The seal member 20 has an oval portion 22 aligned with the normal line to the outer peripheral surface of the valve element 15 that is the object to be sealed, and this oval portion 22 is integrated in a state in which it is retained by the groove wall 18a of the annular groove 18 of the valve housing 11 on the inner side and the outer side of the oval portion 22. Therefore, with this seal member 20, the position at which the oval portion 22 is integrated, as shown in FIG. 3 through FIG. 5, is such that a seal is formed with the valve element 15 along the normal line to the valve element 15, with the position being gradually displaced along the circumference of the seal, with a rectangular portion 21 provided on an outer side thereof.

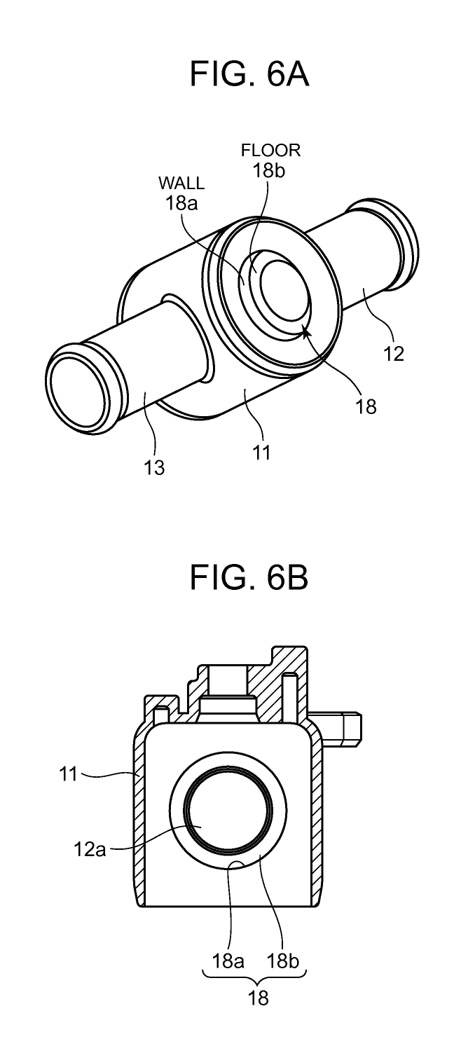

The relation of the seal member 20 to the annular groove 18 and the valve element 15 is as shown in FIG. 6(a), (b) and FIG. 7. That is, the rectangular portion 21 in the seal member 20 is shaped so as to be stably retained by the groove wall 18a of the annular groove 18 formed as shown in FIG. 6(a), with the oval portion 22 integrated into the rectangular portion 21 and aligned with the normal line to the valve element 15.

In other words, the oval portion 22 is shaped so that the first bulge 22 is aligned with the normal line along its entire circumference, and with the oval portion 22 inserted into the groove 18, the rectangular portion 21 is formed so as to fill the space in the groove not occupied by the oval portion 22.

With the seal member 20 having this sort of shape, the rectangular portion 21 and the second bulge 22b of the oval portion 22 are held in the required state by the annular groove 18. Then, the first bulge 22a applies tension to and presses against the valve element 15 in the normal line to the valve element 15 and slidably holds it there to maintain the necessary seal. This sort of seal member 20 is strong enough to resist twisting and maintains a stable shape even as the valve element 15 moves.

In a rotary-type fluid control valve device using the seal member 20 as described above, a clearance that is larger than the when compressed which the seal member 20 protrudes is provided between the inner wall of the valve housing 11 and the outer peripheral surface of the valve element 15. According to the present invention, the rectangular portion 21 does not contact the sliding surface of the cylindrical valve element 15, and thus there is no protrusion of the seal member 20 caused by the sliding action of the cylindrical valve element 15, and moreover, the bulge 22a of the oval portion is retained in such a way that even when the cylindrical valve element 15 slides the bulge 22a of the oval portion 22 does not protrude into the above-described clearance. As a result, this clearance can be designed with a certain amount of leeway.

The above-described rotary valve seal member has the advantage that a larger clearance can be left between the inner wall of the valve housing and the outer peripheral surface of the valve element than with a conventional seal member such as an O-ring, that is, a clearance larger than a gap into which the seal member protrudes when compressed is possible, so that impurities contained in the fluid (for example, metal shavings remaining from the time the engine block was made) do not get caught and good valve action is obtained at all times. This is because, conventionally, this clearance is made as close to zero as possible in consideration of the protrusion of the seal member into the clearance that appears when the valve slides; in other words, this clearance is made smaller than the gap into which the seal member protrudes when compressed in an effort to prevent damage to the seal member, but as a result, impurities can easily clog the valve. In addition, if the clearance were to be made large it would lead to the above-described problem of the seal member protruding into the gap, which is a real problem in actual usage. With the seal member 20 according to the present invention, however, this sort of problem can be solved.

It should be noted that the present invention is not limited to the structures described with respect to the above-described embodiment, and accordingly, the shape and structure of the parts constructing the seal member 20 and a rotary valve using the same can be varied and altered as convenient. Thus, for example, although in the above-described embodiment the seal member 20 is installed in the rim of the opening of the outflow pipe 13 inside the valve housing 11, the present invention is not limited thereto, and alternatively the seal member 20 may be installed in the rim of the opening of the inflow pipe 12. In short, provided that the seal member is one that can be installed to provide a seal with the valve element where needed by the valve construction, it can provide the appropriate effect.

Moreover, although in the above-described embodiment the seal member 20 is described as being a substantially annular ring in shape, the present invention is not limited thereto, and alternatively the seal member 20 may be a multilateral ring with a substantially square cross-section provided that it has a diameter larger than the diameter of the opening of the passage. In short, anything that has a cross-sectional shape that combines the rectangular portion 21 that is fitted into the annular groove 18 and the oval portion 22 having the bulge 22a protruding along the normal line to the outer peripheral surface of the valve element 15 will suffice.

In addition, although applications of a rotary valve using the seal member 20 according to the present invention in automobile cooling systems and plumbing fixtures have been described, the present invention is not limited to such applications.

Moreover, although the seal member 20 according to the present invention is described using a case in which the seal member 20 is adapted to a rotary valve or ball valve that turns or rotates, the present invention is not limited thereto, and alternatively the valve may be one that has a structure in which the valve element 15 is turned in a direction vertical to the passage (up and down in the drawings), for example a shutter valve.

In addition, the second bulge 22b may be omitted from the seal member 20 according to the present invention, in which case the rectangular portion 21 contacts the groove floor 18b of the annular groove 18.

Moreover, although in the above-described embodiment the rectangular portion 21 of the seal member 20 is continued over the entire circumference of the seal member 20 and the circular portion 22 is embedded therewithin to form a single unit, the present invention is not limited to such a configuration. Thus, for example, the rectangular portion 21 may be partially provided at major portions along the circumference of the seal member 20, and a single portion may be configured solely of the oval portion 22. In short, any configuration is acceptable provided that the long axis of the oval portion 22 is configured to extend along the normal line to the outer surface of the valve element.

### PARTIAL LIST OF REFERENCE NUMBERS

10 Flow control valve (Rotary valve)
11 Valve housing
12 Inflow pipe
13 Outflow pipe
14 Valve chamber
15 Cylindrical valve element
16 Passage port
17 Annular groove
18a Groove wall
18b Groove floor
20 Annular seal member
21 Rectangular portion
22 Oval portion
22a Bulge (First bulge)
22b Second bulge

1. A rotary valve seal member for a rotary valve having a cylindrical or spherical valve element that rotates, turns, or slides within a valve housing, comprising a portion of an inner wall surface curved to conform to an outer surface of the valve element within the valve housing, and fitted into an annular groove formed in a rim of an opening of a passage that is opened and closed by the valve element in such a way that a seal member slides over the outer surface of the valve element,
wherein the seal member has the structure of a three-dimensional ring having a cross-section composed of an oval portion that is aligned with a normal line to the outer surface of the valve element, with a first bulge at an end of the oval portion protruded and pressed against the valve element outer surface to seal a portion in contact with the outer surface of the valve element, and a rectangular portion, embedding the oval portion in a state in which the oval portion is aligned with the normal line to the outer surface of the valve element, which is retained within an annular groove, with an outer side of the rectangular portion in contact with a wall of the annular groove,
wherein the seal member is integrally formed of an elastic material.

2. The rotary valve seal member as claimed in claim 1, further comprising a second bulge on an end of the seal member opposite the end with the first bulge and protruding in a direction opposite the normal line so that the seal member is pressed against a floor of the annular groove of the valve housing to exert a biasing force in the direction of the normal line, wherein the seal member forms a ring having a cross-sectional shape that includes the second bulge.

3. The rotary valve seal member as claimed in claim 1, wherein the seal member has an oval portion forming an oval-shaped cross-section having the first bulge and the second bulge, and has a cross-section such that a direction of compression to which the seal member is subjected when the seal member is retained in the annular groove and slides over the outer surface of the valve element is on the normal line to the outer peripheral surface of the valve element, and the same compression rate is maintained at all locations along the circumference of the seal member.

4. The rotary valve seal member as claimed in claim 1, wherein the oval portion that slides over the outer surface of the valve element has a cross-sectional shape that changes continuously along the circumference of the oval portion, so that the oval portion is always aligned with the normal line to the outer surface of the valve element.

5. The rotary valve seal member as claimed in claim 4, wherein the rectangular portion of the seal member has a side forming a ring having an outer peripheral surface retained by the wall of the annular groove and an inner peripheral surface having an inner diameter dimensioned so as not to constrict the opening of the passage, said side being coaxial with a rotatable shaft of the valve element and larger than the outer surface of the valve element viewed from the valve element, and a side smaller than a floor of the annular groove viewed from a side opposite the valve element.

6. The rotary valve comprising the rotary valve seal member as claimed in claim 1,
wherein a clearance greater than a gap into which the seal member protrudes when compressed is provided between an inner wall of the valve housing of the rotary valve and an outer surface of the valve element.
